(19) United States
(12) Patent Application Publication
(10) Pub. No.: US 2006/0232145 A1
(43) Pub. Date: Oct. 19, 2006

(54) System for cooling motors

(75) Inventors: Michael B. Binnard, Belmont, CA (US); Yoichi Arai, Belmont, CA (US); Andrew J. Hazelton, Kanagawa (JP)

Correspondence Address: GREENBLUM & BERNSTEIN, P.L.C., 1950 ROLAND CLARKE PLACE, RESTON, VA, 20191, US

(73) Assignee: NIKON CORPORATION, Tokyo (JP)

(21) Appl. No.: 11/106,521

(22) Filed: Apr. 15, 2005

(51) Int. Cl. H02K 9/00

(52) U.S. Cl. 310/52

(57) ABSTRACT

A system for cooling motors of a lithographic tool. The system includes a core plate having a plurality of outward extending cores. A cover is joined to the core plate or the plurality of outward extending cores, which forms at least one flow path for coolant to remove heat from coils of the motor.

### FIELD OF THE INVENTION

The invention relates generally to a system for cooling motors and more specifically to a system for cooling linear motors of a lithographic tool or device.

### BACKGROUND DESCRIPTION

An exposure apparatus utilizes one or more linear motors to precisely position a wafer stage which holds a semiconductor wafer relative to a reticle. The images transferred onto the wafer from the reticle are extremely small, and precise positioning of the wafer and the reticle is thus critical to the manufacturing of the wafer. To maintain precise control of the positioning of the wafer and reticle, a measuring system is utilized such as a laser interferometer in combination with a wafer stage mirror. The laser interferometer, which is known to be sensitive to air temperature variations, preferably has a wavelength of approximately 630 nm (i.e., red helium-neon laser).

In one type of linear motor, a coil is wrapped about individual magnetic cores or projections, typically made of iron. These coils are referred to as a coil array. A magnet array, mounted on an iron plate, is mounted above these coils, typically leaving a gap of approximately 5 mm between the magnets and each of the iron cores to optimize the performance of the linear motor. In this type of motor, each magnet is usually configured into a parallelogram to prevent a cogging force, i.e., the motor stopping at locations where the magnets are aligned with the magnetic iron core material. A typically arrangement is shown in FIG. 1.

Under ideal situations, the outer surface temperature of the linear motor should be maintained at a very uniform temperature with the surrounding air. That is, the surface temperature must be matched closely to the surrounding air in the exposure apparatus. A typical specification is that the linear motor surface temperature be maintained within approximately 0.1° C. of the surrounding air temperature.

In operation, though, in known linear motors, the surface temperature of the motor is raised significantly thus affecting the operations of the exposure apparatus. By way of example, in operation, the coil array is supplied with an electrical current which, in turn, generates an electromagnetic field that interacts with the magnetic field of the magnet array. This causes the magnet array to move relative to the coil arrays and, when the magnet array is secured to the wafer stage, the wafer stage moves in concert with the magnet array, typically via an air bearing. In this manner, precise movement of the wafer stage can be accomplished in several planes using several linear motors.

In providing an electrical current to the coils, however, heat is generated due to the resistance in the coils. The heat generation rate increases as the linear motor acceleration increases due to increased current requirements. The heat generated from the coils is subsequently transferred to the surrounding environment, including the air surrounding the linear motor and the other components positioned near the motor. This heat expands components of the lithographic machine, thus causing alignment problems and degrading the accuracy of the device. Additionally, the heat changes the index of refraction of the surrounding air which reduces the accuracy of the metrology system and degrades machine positioning accuracy.

Specifically, the heat generated by the coils of the motor raises the air temperature around the motor which changes the index of refraction along the interferometer beam path. This causes noise and error in the interferometer signal. Moreover, the resistance of the coils increases as temperature increases which, in turn, exacerbates the heating problem and reduces the performance and life of the linear motor.

### SUMMARY OF THE INVENTION

In a first aspect of the invention, a system for cooling a motor includes a core plate having a plurality of outward extending cores. A cover is joined to the core plate or the plurality of outward extending cores, which forms at least one flow path for coolant to remove heat from coils of the motor.

In another aspect of the invention, a motor assembly includes a core plate having outward extending cores and coils surrounding each of the outward extending cores. A cover is joined to the core plate or the outward extending cores to form at least one channel which provides a fluid path for fluid to adjust a temperature of the coils. A magnetic assembly is aligned with the outward extending cores and a thermoelectric device adjusting a temperature of the fluid.

In a further aspect of the invention, an exposure apparatus is provided. The exposure apparatus includes an illumination system that irradiates radiant energy on a substrate retained by a stage device and at least one motor assembly that moves the stage device. A system adjusts the temperature of the at least one motor. The system includes at least one flow path, formed by a cover, which provides a fluid path for fluid to adjust a temperature of coils of the at least one motor assembly.

### BRIEF DESCRIPTION OF THE DRAWINGS

FIG. 1 is a representative schematic view of a conventional linear motor;

FIG. 2 shows across sectional side view of a motor assembly in accordance with the invention;

FIG. 3 shows a perspective view of a housing and partial view of a cover in accordance with the invention;

FIG. 4 shows a top view of another embodiment of the motor assembly in accordance with the invention;

FIG. 5 shows an exploded perspective view of another embodiment of the motor assembly in accordance with the invention;

FIG. 6 shows a side view of the motor assembly of FIG. 5 in accordance with the invention;

FIG. 7 shows a perspective view of the assembled motor assembly of FIG. 5 in accordance with the invention;

FIG. 8 shows a partially exploded view of another embodiment of the invention;

FIG. 9 is a schematic view illustrating a photolithography apparatus according to the invention;

FIG. 10 is a flow chart showing semiconductor device fabrication; and

FIG. 11 is a flow chart showing wafer processing.

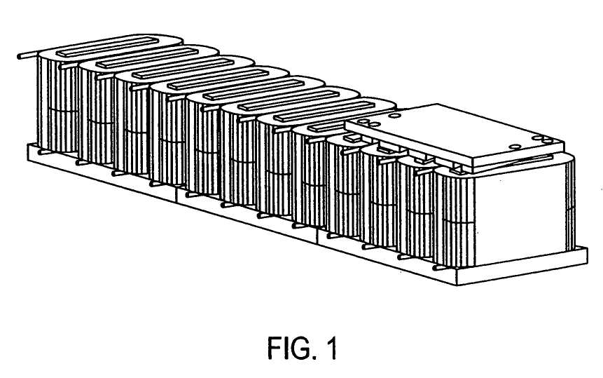

### DETAILED DESCRIPTION OF EMBODIMENTS OF THE INVENTION

The invention is directed to a system and method for cooling linear motors of a lithographic tool. By use of the invention, it is now possible to maintain an outer surface of a linear motor within a set temperature range to control the effect of the linear motor on the surrounding environment and the surrounding components. In one aspect of the invention, a coolant is supplied through at least one channel, about the linear motor. The coolant absorbs the heat generated from the coils of the linear motor, and transfers the heat away from the motor frame. By transferring the heat away from the linear motor, a significant increase in the efficiency of the entire system is achieved, e.g., less degradation of the optics. That is, by efficiently transferring heat away from the motor, more heat can be put into the motor while still maintaining a lower exterior temperature of the frame or other components thereabout.

### Embodiments of the Invention

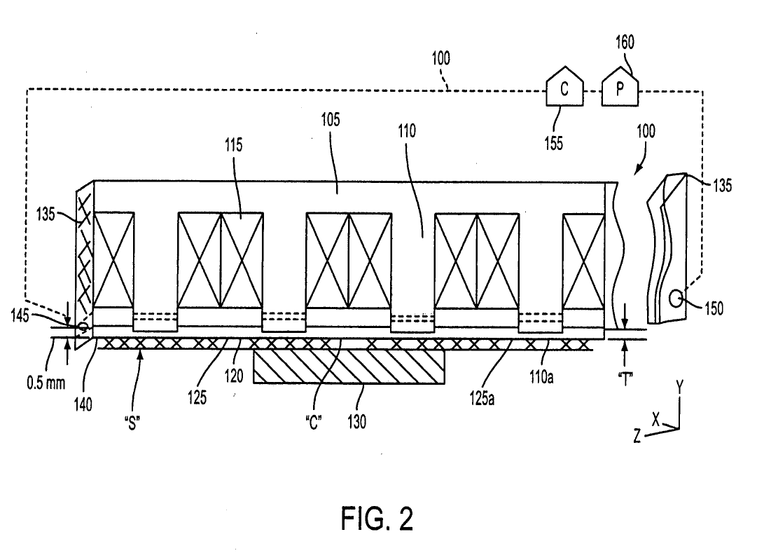

FIG. 2 shows a cross sectional side view of a linear motor assembly in accordance with the invention. The linear motor assembly is generally depicted as reference numeral 100, and includes a core plate 105 having a plurality of outward extending projections or teeth 110 (referred to as cores). In some embodiments, the core plate 105 and the outward extending cores 110 are comprised of iron or any other magnetic material. The outward extending cores 110 may each include one or more fluid passages 110a such as holes to facilitate passage of coolant “C” through the system.

A coil assembly 115 is provided about each core 110. In one embodiment, the cores 110 are lengthened to have an end extending beyond the surface 120 of each of the coils 115. By using the lengthened cores 110, the motor assembly 100 will be taller; however, this should not significantly change the distance between a magnet array 130 and the iron (magnetic) cores 110, thus not significantly affecting the efficiency of the motor.

Still referring to FIG. 2, a plate or cover 125 is placed over the coil array surface 120. In one embodiment, the cover 125 is glued or otherwise bonded to one or more of the cores 110. The cover 125 may also be held in place over the coil array surface 120 by a vacuum force, e.g., pressure below atmospheric pressure. The cover 125 is composed of a non-magnetic material, preferably having insulating properties. This will prevent heat transferring from the motor to the environment or other components. The material of the cover 125 may include ceramic, plastic, aluminum or the like. In one implementation, the cover 125 is a carbon fiber reinforced plastic (CRRP). The magnet assembly 130 is provided over the cover 125.

The cover 125 may include pockets or detents 125a located in alignment with the ends of the cores 110. The pockets or detents 125a will effectively reduce the thickness “T” of the cover 125, at the aligned location of the respective core 110. In one implementation, the overall thickness of the cover 125 is approximately 0.5 mm, with the thickness “T” at the pockets or detents 125a being approximately 0.1 mm. The reduced thickness “T”, in combination with the extended cores 110, will optimize the spacing “S” between the magnet assembly 130 and the cores 110. In one embodiment, the spacing “S” is approximately 5 mm to 6 mm; although other spacing may also be implemented with the present invention.

A housing or other partial type enclosure 135 is placed about portions of the linear motor. The combination of the housing 135 and the cover 125 will form at least one channel 140. The at least one channel 140 will act as a flow path for coolant “C” to pass over the motor. The coolant “C” will be supplied into the at least one channel 140 via an inlet 145 and exit the channel 140 via an outlet 150. The coolant “C” may be water or a refrigerant such as, for example, HFE manufactured by 3M™ Corporation or HFC 236-PA from DuPont. The coolant “C”, while in the channel 140, may be at less than atmospheric pressure so that the resultant air pressure holds the cover 125 against the cores 110.

As further shown in FIG. 2, a chiller 155 and pump 160 are in the flow path of the coolant “C”. The flow path is represented by the dashed lines of FIG. 2, between the inlet 145 and the outlet 150. The pump 160 will supply the coolant “C” to the at least one channel 140 via the inlet 145; whereas, the chiller 155 will adjust the temperature of the coolant “C”, after it exits the outlet 150. It should be understood that the pump 160 and chiller 155 or other thermoelectric device may be a single operating unit.

According to the embodiment of FIG. 2, the coolant “C” flows across the length of the motor, e.g., along the z axis, through the at least one channel 140. This results in the coolant “C” flowing along a top portion of the coils, through the passages 110a of the cores 110, absorbing the heat generated by the coils. To maintain a desired temperature range of the motor, e.g., within 1° C., the coolant “C” will preferably have a flow rate of approximately 1 to 10 liters per minute. This results in a temperature change of the lithographic machine of about 1° C. and preferably less than 1° C. at critical components such as those components near the optic path. It should be recognized by those of skill in the art, though, that other flow rates are also contemplated by the invention, depending on such variables as the current supplied to the coils, the energy output of the motor, the size and material of the components.

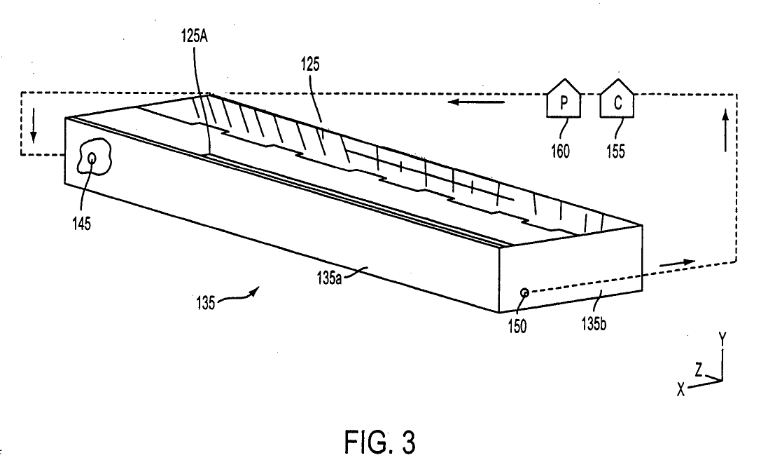

FIG. 3 shows a schematic of the housing 135 and a partial view of the cover 125. The housing 135 includes side walls 135a and end walls 135b. The opposing end walls 135b include the inlet 145 and the outlet 150. The housing 135 and cover 125 will enclose the motor and form the at least one channel 140.

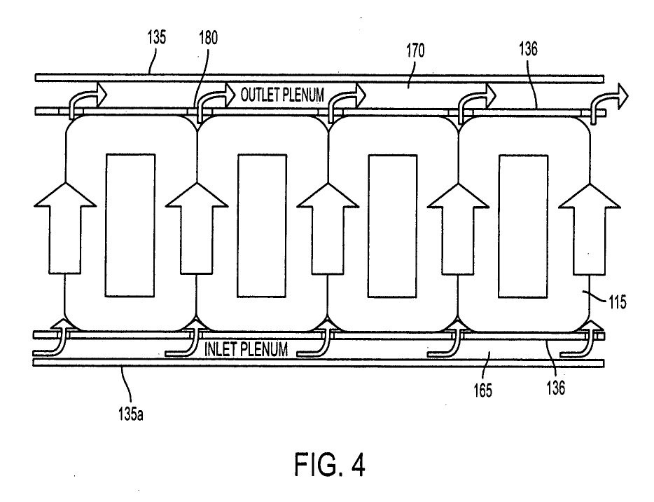

FIG. 4 shows a top view of another exemplary embodiment of the invention. In FIG. 4, an inlet plenum 165 and an outlet plenum 170 are formed partly with opposing sidewalls 135a of the housing 135. The plenums 165 and 170, e.g., space between housing wall 135a and outer wall, are approximately between 1 mm and 5 mm, although other spacing are also contemplated by the invention. For example, the spacing may be dependent on the flow rate of the coolant, the size of the motor, etc. In this embodiment, the flow passages 110a may be eliminated. Without departing from the invention, and utilizing the same principles as described with reference to FIG. 4, both the inlet plenum 165 and the outlet plenum 170 may be eliminated, with tubes or other passages being used to supply the coolant “C” to and from the at least one channel 140.

At least one and preferably plurality of flow restricting orifices 175 are provided in the sidewalls 135a, located between respective coils 115. The plurality of flow restricting orifices 175 regulate the flow rate of the coolant “C”, and are designed to ensure that coolant “C” flows through the inlet plenum 165. The diameter of the flow restricting orifices 175 is designed to maintain a slight pressure difference between the motor chamber (e.g., channel) and the inlet plenum 165 to allow the coolant “C” to flow along an entire length of the motor. The diameter of the exit orifice 180 should be larger than the flow restricting orifices 175 to prevent restriction of the coolant at the exit end of the system; although, under some circumstances, the diameter of the exit orifice 180 may be adjusted. In an embodiment, the coils may be made slightly smaller, leaving a space therebetween to facilitate the flow of the coolant “C”.

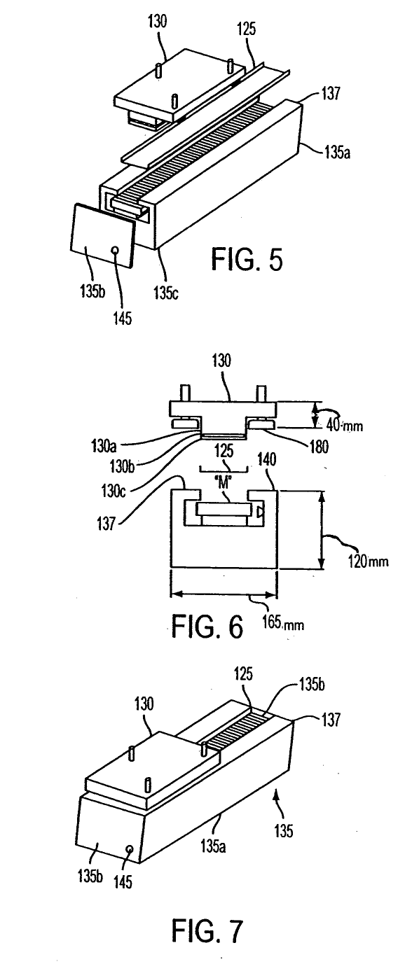

FIG. 5 is an exploded view of another embodiment of the linear motor assembly of the invention. As shown in FIG. 5, the motor is housed within a channel 135c of the housing 135. The side walls 135a of the housing 135 form rails 137. The cover 125 is placed within the channel 135c, below a surface of the rails 137. The at least one channel 140 is formed by the combination of the sidewalls 135a, the end walls 135b and cover 125 and, in embodiments, either the core plate 105 or a bottom portion of the housing 135. The inlet 140 is provided in the end plate 135b.

FIG. 6 is a side cut away view of the linear motor assembly 100 of FIG. 5, and FIG. 7 depicts an assembled linear motor assembly 100. The magnetic assembly 130 includes an iron backing 130b and air bearings 180 mounted to a holder 130a. A magnet array 130c is mounted to the iron backing 130b which, when assembled, will sit between the rails 137. In this configuration, the air bearings 180, upon energizing the motor, will glide along the rails 137.

The cover 125 is interposed between the motor assembly “M” and the magnetic assembly 130. In one exemplary embodiment, (i) the air bearing and portion of the housing is approximately 40 mm, (ii) the height of the sidewalls 135a is approximately 120 mm, and (iii) the width of the housing is approximately 165 mm. In this embodiment, as well as the other disclosed embodiments, the housing 135 may be made of stainless steel or aluminum. As in the above described embodiments, the coolant flows through the at least one channel 140 and removes heat from the coils of the motor.

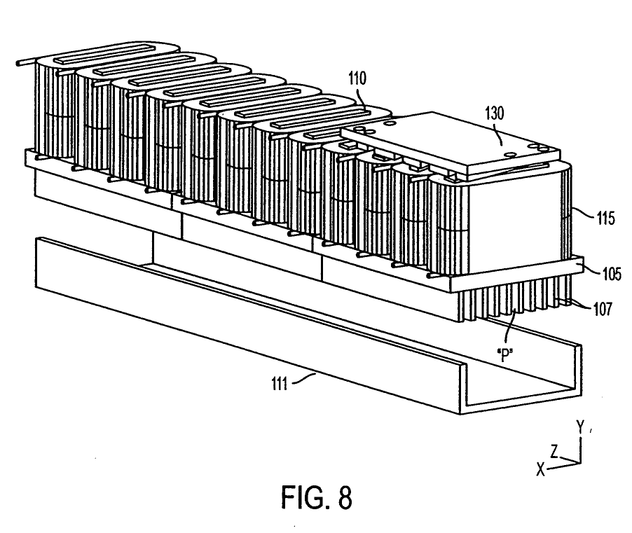

FIG. 8 shows a partially exploded view of another embodiment of the invention. In this embodiment, the core plate 105 includes heat transfer fins 107 arranged along the length of the assembly, e.g., z-axis. The fins 107 form channels “P” along the length of the core plate 105. The channels 140 may be formed partly by with the cover 109, which is part of a housing 109a. In this embodiment, coolant “C” flows through the flow paths, removing heat generated from the motor.

It should further be recognized that any of the embodiments can be combined together to efficiently cool the motor. For example, a channel may be formed below the core plate, as in the embodiment of FIG. 8, in addition to a plenum system, as shown in FIG. 4. Also, as another exemplary combination, the system of FIGS. 5-7 may be combined with the embodiment of FIG. 4 or FIG. 8.

### Lithographic Tool Implementing Embodiments of the Invention

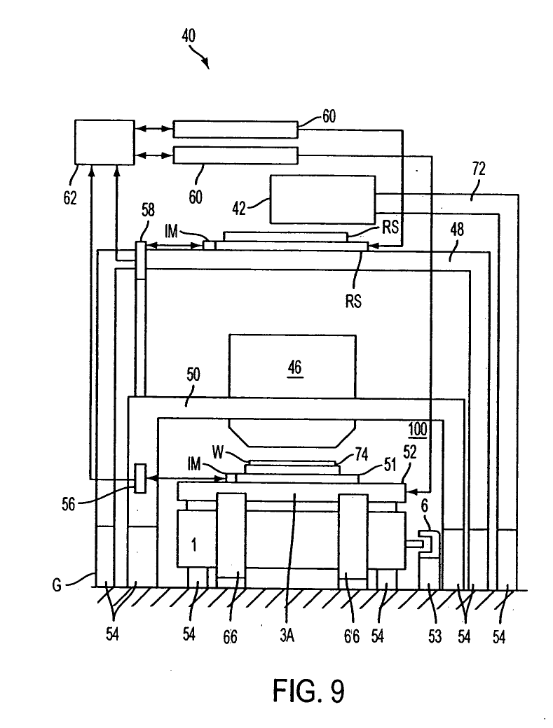

FIG. 9 is a schematic view illustrating a photolithography apparatus (exposure apparatus) 40 in accordance with the invention. The apparatus may utilize any of the embodiments of the linear motor, described above. The wafer positioning stage 52 includes a wafer stage 51, a base 1, a following stage 3A, a following stage base 3A, and an additional actuator 6. The wafer stage 51 comprises a wafer chuck 120 that holds a wafer 130 and an interferometer mirror IM. The base 1 is supported by a plurality of isolators 54 (or a reaction frame). The isolator 54 may include a gimbal air bearing 105. The following stage base 3A is supported by a wafer stage frame (reaction frame) 66. The additional actuator 6 is supported on the ground G through a reaction frame 53. The wafer positioning stage 52 is structured so that it can move the wafer stage 51 in multiple (e.g., three to six) degrees of freedom under precision control by a drive control unit 140 and system controller 30, and position and orient the wafer 130 as desired relative to the projection optics 46. In this embodiment, the wafer stage 51 has six degrees of freedom by utilizing the Z direction forces generated by the x motor and the y motor of the wafer positioning stage 52 to control a leveling of the wafer 130. However, a wafer table having three degrees of freedom (Z, 2x, 2y) or six degrees of freedom can be attached to the wafer stage 51 to control the leveling of the wafer. The wafer table includes the wafer chuck 120, at least three voice coil motors (not shown), and bearing system. The wafer table is levitated in the vertical plane by the voice coil motors and supported on the wafer stage 51 by the bearing system so that the wafer table can move relative to the wafer stage 51.

The reaction force generated by the wafer stage 51 motion in the X direction can be canceled by motion of the base 1 and the additional actuator 6. Further, the reaction force generated by the wafer stage motion in the Y direction can be canceled by the motion of the following stage base 3A.

An illumination system 42 is supported by a frame 72. The illumination system 42 projects radiant energy (e.g., light) through a mask pattern on a reticle R that is supported by and scanned using a reticle stage RS. In one embodiment, the reticle stage RS may have a reticle coarse stage for coarse motion and a reticle fine stage for fine motion. In this case, the reticle coarse stage corresponds to the translation stage table 100, with one degree of freedom. The reaction force generated by the motion of the reticle stage RS can be mechanically released to the ground through a reticle stage frame 48 and the isolator 54, in accordance with the structures described in JP Hei 8-330224 and U.S. Pat. No. 5,874,820, the entire contents of which are incorporated by reference herein. The light is focused through a projection optical system (lens assembly) 46 supported on a projection optics frame 75 and released to the ground through isolator 54.

An interferometer 56 is supported on the projection optics frame 75 and detects the position of the wafer stage 51 and outputs the information of the position of the wafer stage 51 to the system controller 30. A second interferometer 58 is supported on the projection optics frame 75 and detects the position of the reticle stage RS and outputs the information of the position to the system controller 30. The system controller 30 controls a drive control unit 140 to position the reticle R at a desired position and orientation relative to the wafer 130 or the projection optics 46. By using the system and method of the present invention, accuracy of the interferometer is maintained.

There are a number of different types of photolithographic devices. For example, apparatus 70 may comprise an exposure apparatus that can be used as a scanning type photolithography system, which exposes the pattern from reticle R onto wafer 130 with reticle R and wafer 130 moving synchronously. In a scanning type lithographic device, reticle R is moved perpendicular to an optical axis of projection optics 46 by reticle stage RS and wafer 130 is moved perpendicular to an optical axis of projection optics 46 by wafer positioning stage 52. Scanning of reticle R and wafer 130 occurs while reticle R and wafer 130 are moving synchronously but in opposite directions along mutually parallel axes parallel to the x-axis.

Alternatively, exposure apparatus 70 can be a step-and-repeat type photolithography system that exposes reticle R while reticle R and wafer 130 are stationary. In the step and repeat process, wafer 130 is in a fixed position relative to reticle R and projection optics 46 during the exposure of an individual field. Subsequently, between consecutive exposure steps, wafer 130 is consecutively moved by wafer positioning stage 52 perpendicular to the optical axis of projection optics 46 so that the next field of semiconductor wafer 130 is brought into position relative to projection optics 46 and reticle R for exposure. Following this process, the images on reticle R are sequentially exposed onto the fields of wafer 130 so that the next field of semiconductor wafer 130 is brought into position relative to projection optics 46 and reticle R.

However, the use of apparatus 70 provided herein is not limited to a photolithography system for semiconductor manufacturing. Apparatus 70 (e.g., an exposure apparatus), for example can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines.

In the illumination system 42, the illumination source can be g-line (436 nm), i-line (365 nm), KrF excimer laser (248 nm), ArF excimer laser (193 nm) or F₂ laser (157 nm). Alternatively, the illumination source can also use charged particle beams such as x-rays and electron beam. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask.

With respect to projection optics 46, when far ultra-violet rays such as the excimer laser is used, glass materials such as quartz and fluorite that transmit far ultra-violet rays are preferably used. When the F₂ type laser or x-rays are used, projection optics 46 should preferably be either catadioptric or refractive (a reticle should also preferably be a reflective type), and when an electron beam is used, electron optics should preferably comprise electron lenses and deflectors. The optical path for the electron beams should be traced in vacuum.

Also, with an exposure device that employs vacuum ultra-violet radiation (VUV) of wavelength 200 nm or shorter, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japanese Patent Application Disclosure No. 10-20195 and its counterpart U.S. Pat. No. 5,835,275. In these cases, the reflecting optical device can be a catadioptric optical system incorporating a beam splitter and concave mirror. Japanese Patent Application Disclosure No. 8-334695 published in the Official Gazette for Laid-Open Patent Applications and its counterpart U.S. Pat. No. 5,689,377 as well as Japanese Patent Application Disclosure No. 10-3039 and its counterpart U.S. Pat. No. 5,892,117 also use a reflecting-refracting type of optical system incorporating a concave mirror, etc., but without a beam splitter, and can also be employed with this invention. The disclosures in the above-mentioned U.S. patents, as well as the Japanese patent applications published in the Office Gazette for Laid-Open Patent Applications are incorporated herein by reference.

Further, in photolithography systems, when linear motors that differ from the motors shown in the above embodiments (see U.S. Pat. Nos. 5,623,853 or 5,528,118) are used in one of a wafer stage or a reticle stage, the linear motors can be either an air levitation type employing air bearings or a magnetic levitation type using Lorentz force or reactance force. Additionally, the stage could move along a guide, or it could be a guideless type stage that uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Movement of the stages as described above generates reaction forces that can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As described above, a photolithography system according to the above described embodiments can be built by assembling various subsystems in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

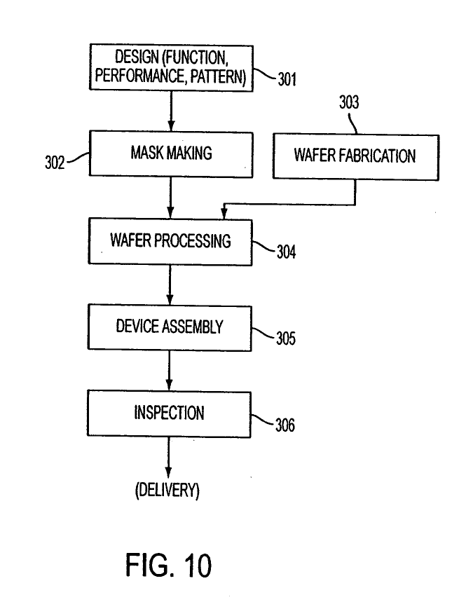

Further, semiconductor devices can be fabricated using the above described systems, by the process shown generally in FIG. 10. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system described hereinabove consistent with the principles of the present invention. In step 305 the semiconductor device is assembled (including the dicing process, bonding process and packaging process), then finally the device is inspected in step 306.

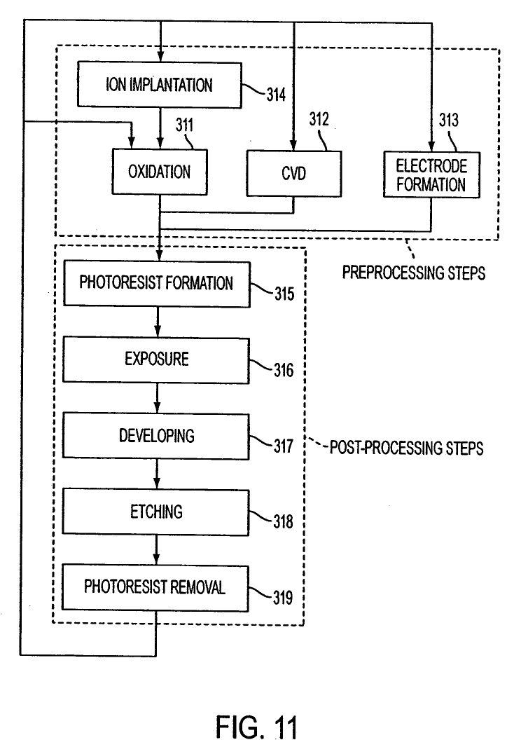

FIG. 11 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above-mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially in step 315 (photoresist formation step), photoresist is applied to a wafer. Next, in step 316 (exposure step), the above-mentioned exposure apparatus is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed. Multiple circuit patterns are formed by repetition of these pre-processing and post-processing steps.

Although the invention has been particularly discussed in a photolithography system as an exemplary example, the inventive products, methods and systems may be used in other and further contexts, including any applications where it is desired to maintain a desired boiling temperature of a coolant for cooling a motor, such as precision apparatuses (e.g., photography system). Thus, while the invention has been described in terms of its embodiments, those skilled in the art will recognize that the invention can be practiced with modifications within the spirit and scope of the appended claims. Thus, it is intended that all matter contained in the foregoing description or shown in the accompanying drawings shall be interpreted as illustrative rather than limiting, and the invention should be defined only in accordance with the following claims and their equivalents.

What is claimed is:

1. A system for adjusting a temperature of a motor, comprising:
a core plate having a plurality of outward extending cores; and
a cover, joined to the core plate or the plurality of outward extending cores, forming at least one flow path for fluid to adjust a temperature of the motor.

2. The system of claim 1, wherein an end of the outward extending cores extends beyond a coil surface of the coils.

3. The system of claim 2, wherein the cover includes pockets which are aligned with and joined to the ends of the outward extending cores, the pockets reduce an effective thickness of the cover at locations aligned with at least one of the coils.

4. The system of claim 1, wherein the cover is attached to the outward extending cores, which have ends extending beyond a coil surface of the coils, at least one of the outward extending cores having a flow passage communicating with sections of the at least one flow path.

5. The system of claim 1, wherein the cover is attached to the outward extending cores by glue or a vacuum pressure.

6. The system of claim 1, wherein the cover is a non-magnetic material.

7. The system of claim 1, wherein the cover is made from carbon fiber reinforced plastic.

8. The system of claim 1, further comprising a magnetic assembly, wherein
the cover is located between the magnetic assembly and the outward extending cores; and
a thickness of the cover is reduced at a location between magnets of the magnetic assembly and the outward extending cores.

9. The system of claim 8, wherein the reduced thickness of the cover results in a space of approximately 5 mm to 6 mm between the magnets of the magnetic assembly and respective ones of the plurality of outward extending cores.

10. The system of claim 1, further comprising a partial enclosure which forms, with the cover, the at least one flow path along a length of the motor.

11. The system of 10, wherein the partial enclosure comprises sidewalls and endwalls, an inlet is provided in one of the endwalls and an outlet is provided in an opposing one of the endwalls to provide ingress and egress of the fluid to and away the flow path.

12. The system of claim 11, further comprising a thermoelectric device and a pump in flow communication with the inlet and the outlet, the pump supplying the fluid to the inlet and the thermoelectric device adjusting a temperature of the fluid after it exits the outlet.

13. The system of claim 1, wherein the fluid has a flow rate of approximately 1 to 10 liters per minute.

14. The system of claim 1, further comprising heat transfer fins extending from the core plate, at a side opposed to the outward extending cores, the cover is attached to the heat transfer fins to form the at least one flow path between the heat transfer fins.

15. The system of claim 1, further comprising:
an inlet plenum;
an outlet plenum;
at least one flow restricting orifice associated with the inlet plenum and communicating with the at least one flow path; and
at least one exit orifice associated with the outlet plenum and communicating with the at least one flow path,
wherein the fluid passes through the at least one flow restricting orifice to the at least one flow path.

16. The system of claim 15, wherein the at least one flow restricting orifice regulates the flow rate of the fluid through the inlet plenum and the at least one flow path.

17. The system of claim 15, wherein a diameter of the at least one exit orifice is larger than a diameter of the at least one flow restricting orifice.

18. The system of claim 1, further comprising:
a housing having a longitudinal channel and side rails; and
a magnetic assembly including air bearings and a magnetic array, the air bearing gliding along the side rails, upon energizing the motor, wherein
the cover is placed within the channel, and
the at least one flow path is formed by the cover and portions of the housing.

19. The system of claim 18, wherein the cover is interposed between the coils and the magnetic assembly.

20. A motor assembly, comprising:
a core plate having outward extending cores and coils surrounding each of the outward extending cores;
a cover joined to the core plate or the outward extending cores to form at least one channel which provides a fluid path for fluid to adjust a temperature of the coils;
a magnetic assembly aligned with the outward extending cores; and
a thermoelectric device adjusting a temperature of the fluid.

21. The system of claim 20, wherein:
the outward extending cores each have an end which extends beyond a surface of the coils;
the cover includes detents or pockets which are aligned with the outward extending cores, the detents or pockets reduce an effective thickness of the plate at locations aligned with at least one of the coils; and
at least one of the outward extending cores have a flow passage in flow communication with the at least one channel.

22. The system of claim 21, wherein the detents or pocket provide a reduced thickness of the cover resulting in a space of approximately 5 mm to 6 mm between magnets of the magnetic assembly and respective ones of the outward extending cores.

23. The system of claim 20, wherein the cover is a non-magnetic material.

24. The system of claim 20, further comprising:
a housing having sidewalls and endwalls,
an inlet provided in one of the endwalls to provide ingress of the fluid to the at least one channel; and
an outlet provided in an opposing one of the endwalls to provide egress of the fluid away from the at least one channel.

25. The system of claim 20, wherein the fluid has a flow rate of approximately 1 to 10 liters per minute.

26. The system of claim 20, further comprising heat transfer fins extending from the core plate at a side opposite to the cores, the cover and the heat transfer fins forming the at least one channel.

27. The system of claim 20, further comprising:
an inlet plenum;
an outlet plenum;
a plurality of flow restricting orifices associated with the inlet plenum and communicating with the at least one channel; and
a plurality of exit orifices associated with the outlet plenum and communicating with the at least one channel.

28. The system of claim 20, further comprising:
a housing having a longitudinal channel and side rails; and
a magnetic assembly including air bearings and a magnetic array, the air bearing gliding along the side rails, upon energizing the motor.

29. The system of claim 20, wherein the cover is interposed between the coils and the magnetic assembly.

30. An exposure apparatus, comprising:
an illumination system that irradiates radiant energy on a substrate retained by a stage device;
at least one motor assembly that moves the stage device; and
a system for adjusts the temperature of the at least one motor, the system including at least one flow path, formed by a cover, which provides a fluid path for fluid to adjust a temperature of coils of the at least one motor assembly.

31. A device manufactured with the exposure apparatus of claim 30.

32. A wafer on which an image has been formed by the exposure apparatus of claim 30.

33. The exposure apparatus of claim 30, further comprising:
a core plate having a plurality of outward extending cores; and
the cover joined to the core plate or the plurality of outward extending cores to form the flow path for coolant to remove heat from coils of the motor.

34. The exposure apparatus of claim 30, wherein the motor is mounted on a reticle stage.

35. The exposure apparatus of claim 33, further comprising heat transfer fins extending from the core plate at a side opposite to the cores, the cover and the heat transfer fins forming the flow path for coolant.

36. The exposure apparatus of claim 33, further comprising:
an inlet plenum;
an outlet plenum;
a plurality of flow restricting orifices associated with the inlet plenum and communicating with the flow path; and
a plurality of exit orifices associated with the outlet plenum and communicating with the flow path.

37. The exposure apparatus of claim 33, wherein the cover is attached to the outward extending cores, which have ends extending beyond a coil surface of the coils, at least one of the outward extending cores having a flow passage communicating with sections of the flow path.
